(19) United States
(12) Patent Application Publication
(10) Pub. No.: US 2025/0378811 A1
(43) Pub. Date: Dec. 11, 2025

(54) ACOUSTIC ATTENUATION PANEL COMPRISING AT LEAST ONE C-SHAPED REINFORCEMENT HELD BY AT LEAST ONE EXPANDABLE CORE AND METHOD FOR MANUFACTURING SUCH A PANEL

(71) Applicant: Airbus SAS, BLAGNAC (FR)

(72) Inventors: Florian RAVISE, ROCHEFORT (FR); Arnaud METAYER, ROCHEFORT (FR); Julien DOUSSET, ROCHEFORT (FR); Marc COUVET, ROCHEFORT (FR); Hassan MENAY, ROCHEFORT (FR)

(21) Appl. No.: 19/231,682

(22) Filed: Jun. 9, 2025

(30) Foreign Application Priority Data
Jun. 10, 2024 (FR) FR2406082

(51) Int. Cl. G10K 11/168; B29D 24/00; B32B 3/08; B32B 3/12

(52) U.S. Cl. CPC G10K 11/168; B32B 3/08; B32B 3/12; B29D 24/002; B32B 2605/18

(57) ABSTRACT

An acoustic attenuation panel with at least one acoustically resistive layer, at least one reflective layer, at least one cellular structure and at least one C-shaped reinforcement which are interposed between the acoustically resistive and reflective layers, and at least one expandable core, positioned between the first and second wings of the C-shaped reinforcement, which increases in volume during a polymerization cycle. Also a method for manufacturing such a panel.

### CROSS-REFERENCES TO RELATED APPLICATIONS

This application claims the benefit of French Patent Application Number FR2406082 filed on Jun. 10, 2024, the entire disclosure of which is incorporated herein by way of reference.

### FIELD OF THE INVENTION

The present application relates to an acoustic attenuation panel comprising at least one C-shaped reinforcement held by at least one expandable core, and to a method for manufacturing such a panel.

### BACKGROUND OF THE INVENTION

According to one embodiment visible in FIG. 1, an aircraft 10 comprises a fuselage 12, wings 14 positioned on either side of the fuselage 12, and also a plurality of propulsion units 16 positioned under the wings 14 and connected thereto by pylons 18. Each propulsion unit 16 comprises a drive system 20 and a nacelle 22 surrounding the drive system 20 and notably enabling an incoming air flow to be channeled toward the drive system 20.

The drive system 20 has an axis of rotation A20. In the remainder of the description, a longitudinal direction is a direction parallel to the axis of rotation A20. A longitudinal plane is a plane containing the axis of rotation A20. A radial direction is perpendicular to the axis of rotation A20.

Each nacelle 22 comprises, at the front, an air inlet 24 comprising a lip 26, which has the shape of a C in section in a longitudinal plane, and an inner duct 28 which extends the lip 26 inside the nacelle 22 and channels the incoming air flow toward the drive system 20.

According to one configuration, the inner duct 28 comprises at least one acoustic attenuation panel 30 (illustrated in FIG. 2) which extends between front and rear edges 30.1, 30.2 and comprises, in the direction moving away from the axis A20 of the drive system, at least one porous acoustically resistive layer 32, at least one cellular structure 34 and a (non-porous or fluid-tight) reflective layer 36.

According to one embodiment, at the front edge 30.1, the cellular structure 34 comprises a cellular reinforcement 34.1 which has a triangular or trapezoid section. In addition, the reflective layer 36 is pressed against the acoustically resistive layer 32 and connected thereto. At the rear edge 30.2, the acoustic attenuation panel 30 comprises a C-shaped reinforcement 38 which has a web 38.1 and two wings 38.2, 38.3 situated at the ends of the web 38.1, a first wing 38.2 being pressed against the acoustically resistive layer 32 and connected thereto, the second wing 38.3 being pressed against the reflective layer 36 and connected thereto.

According to one configuration, the acoustic attenuation panel is essentially made of composite material. In this case, a method for manufacturing an acoustic attenuation panel comprises a first step of placing an acoustically resistive layer 32 on a first mold, a step of winding a wire around the acoustically resistive layer 32, and a step of introducing a C-shaped reinforcement.

Subsequently, the method comprises a step of introducing a polymerization tool, and a first cycle for polymerizing the acoustically resistive layer 32 and the C-shaped reinforcement 38.

The method also comprises a step of obtaining a cellular structure 34, a step of introducing said cellular structure 34 onto the acoustically resistive layer 32 which is already at least partially polymerized, a step of laying up the reflective layer 36, and then a second polymerization cycle which aims to harden and connect the wound acoustically resistive layer 32, the C-shaped reinforcement 38, the cellular structure 34 and the reflective layer 36.

The first polymerization cycle provides the C-shaped reinforcement 38 with a certain degree of stiffness allowing it to be able to react the compressive loads which tend to move the reflective layer 36 and the acoustically resistive layer 32 toward one another during the second polymerization cycle.

This method for manufacturing an acoustic attenuation panel is not satisfactory because the presence of two polymerization cycles leads to an increase in the time and the energy consumption required for manufacturing the panel. Furthermore, the assembly of the first sub-assembly polymerized after the first polymerization cycle, of the cellular structure 34 and of the reflective layer 36 entails the use of specific composite materials, notably thermoplastic composite materials, and/or the presence of joining elements interposed between, for the one part, the acoustically resistive layer 32 and the C-shaped reinforcement 38 which are already polymerized, and, for the other part, the cellular structure 34 and the reflective layer 36 in order to obtain a solid connection between these elements during the second polymerization cycle.

The present invention seeks to overcome all or some of the drawbacks of the prior art.

### SUMMARY OF THE INVENTION

To this end, the invention relates to an acoustic attenuation panel comprising at least one acoustically resistive layer, at least one reflective layer, and at least one cellular structure and at least one C-shaped reinforcement which are interposed between the acoustically resistive and reflective layers, said C-shaped reinforcement comprising a web and first and second wings in contact respectively with the acoustically resistive and reflective layers.

According to the invention, the acoustic attenuation panel comprises at least one expandable core positioned between the first and second wings of the C-shaped reinforcement and configured to occupy a non-expanded first state, at a first temperature, in which the expandable core occupies a first volume, and an expanded second state, at a second temperature greater than the first temperature, in which the expandable core occupies a second volume greater than the first volume.

The expandable core prevents the C-shaped reinforcement from deforming and allows it to react the compressive loads which tend to move the reflective layer and the acoustically resistive layer toward one another during the polymerization cycle. Therefore, it is not necessary to provide two polymerization cycles, including a first cycle for stiffening the C-shaped reinforcement. The fact of providing only one polymerization cycle makes it possible to reduce the time and the manufacturing costs.

According to another feature, the expandable core has, in the first state, shapes which conform to those of the web and of the first and second wings of the C-shaped reinforcement.

According to another feature, the expandable core has, in the first state, a substantially rectangular section which has a length substantially (i.e., +/−10%) equal to a spacing between the first and second wings and a width substantially equal to that of the first and second wings.

According to another feature, the acoustic attenuation panel comprises a plurality of expandable cores placed end to end.

According to another feature, at least one expandable core is produced from a solid material such as an expandable foam.

According to another feature, at least one expandable core comprises at least one bladder containing an expandable fluid.

According to another feature, at least one expandable core is permanently positioned in the acoustic attenuation panel.

According to another feature, the first temperature is equal to an ambient temperature, of the order of 20° C., and the second temperature is equal to a polymerization temperature greater than or equal to 100° C.

The invention also relates to a method for manufacturing an acoustic attenuation panel according to one of the preceding features.

This manufacturing method comprises a step of introducing at least one acoustically resistive layer, at least one C-shaped reinforcement, at least one cellular structure and at least one reflective layer, each cellular structure and each C-shaped reinforcement being interposed between the acoustically resistive and reflective layers, a step of introducing at least one polymerization tool, a polymerization cycle and a demolding step. According to the invention, the method comprises a step of introducing at least one expandable core between the first and second wings of the C-shaped reinforcement prior to the polymerization cycle, said expandable core being configured to occupy a non-expanded first state, at a first temperature, in which the expandable core occupies a first volume, and an expanded second state, at a second temperature greater than the first temperature, in which the expandable core occupies a second volume greater than the first volume.

### BRIEF DESCRIPTION OF THE DRAWINGS

Other features and advantages will become apparent from the following description of the invention, the description being given solely by way of example, with reference to the appended drawings, in which:

FIG. 1 is a perspective view of an aircraft and of a propulsion unit illustrating one embodiment,

FIG. 2 is a longitudinal section of an acoustic attenuation panel illustrating one embodiment of the prior art,

FIG. 3 is a longitudinal section of a rear part of the acoustic attenuation panel visible in FIG. 2,

FIG. 4 is a longitudinal section of an acoustic attenuation panel illustrating one embodiment of the invention,

FIG. 5 is a longitudinal section of a rear part of the acoustic attenuation panel visible in FIG. 4,

FIG. 6 is a longitudinal section of an acoustically resistive layer, of a rear reinforcement and of an expandable core illustrating one embodiment of the invention.

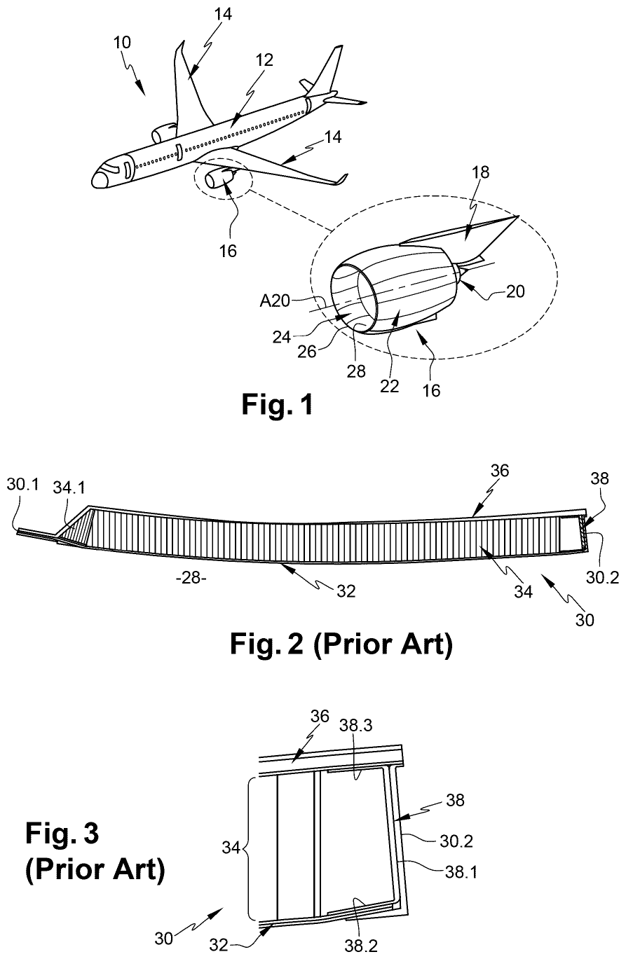

### DETAILED DESCRIPTION OF THE PREFERRED EMBODIMENTS

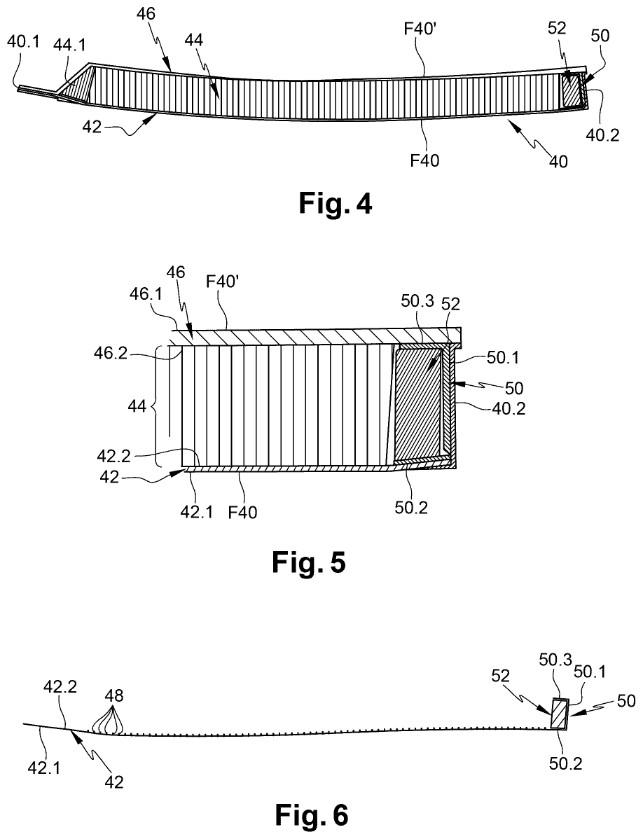

According to one embodiment visible in FIGS. 4 and 5, an acoustic attenuation panel 40 extends between first and second faces F40, F40′ which are offset in a first direction and front and rear edges 40.1, 40.2 which are offset in a second direction. In operation, the first face F40 is in contact with an environment in which sound waves are present.

According to one application, an aircraft comprises at least one acoustic attenuation panel 40, notably at an air inlet of a nacelle of a propulsion unit. In this case, the first and second directions correspond respectively to the radial and longitudinal directions of the propulsion unit.

Of course, the invention is not limited to this application for the acoustic attenuation panel 40.

The acoustic attenuation panel 40 comprises, in a direction moving away from the first face F40, at least one porous acoustically resistive layer 42, at least one cellular structure 44 and at least one reflective layer 46.

The acoustically resistive layer 42 has a first face 42.1 forming the first face F40 of the acoustic attenuation panel 40, and a second face 42.2 opposite the first face 42.1 and oriented toward the cellular structure 44.

According to one arrangement, the acoustically resistive layer 42 is tubular and shaped like an inner duct of an air inlet. In a variant, the acoustically resistive layer 42 is substantially planar or corresponds to a portion of a cylinder. Of course, the invention is not limited to these arrangements.

According to one configuration, the acoustically resistive layer 42 comprises at least one wire 48 (visible in FIG. 6) in contact with the second face 42.2 of the acoustically resistive layer 42. “Wire” is understood for the present application to mean a single wire or a plurality of stranded wires for example.

According to one operating mode, the wire 48 is wound on the second face 42.2 of the acoustically resistive layer 42 when the latter is tubular. This wire 48 may be self-adhesive in order to reinforce the connection between the acoustically resistive layer 42 and the cellular structure 44. In a variant, the wire 48 could be replaced by at least one attachment ply and/or at least one self-adhesive strip or any other element which promotes the connection between the acoustically resistive layer 42 and the cellular structure 44.

According to one embodiment, the acoustically resistive layer 42 is a perforated plate made of thermoplastic material. Of course, the invention is not limited to this embodiment. Thus, the acoustically resistive layer 42 may be metal, made of composite material or be constituted of a mixture of elements made of composite material, metal, solid or woven. By way of indication, the acoustically resistive layer 42 has a thickness of the order of 0.3 mm, give or take a few millimeters.

The reflective layer 46 has a first face 46.1 forming the second face F40′ of the acoustic attenuation panel 40, and a second face 46.2 opposite the first face and oriented toward the cellular structure 44.

According to one embodiment, the reflective layer 36 may be metal, made of composite material or be constituted of a mixture of elements made of composite material and metal. By way of indication, the reflective layer 36 has a thickness of the order of a few tens of millimeters to a few millimeters.

According to embodiments, the acoustic attenuation panel 40 may comprise a single cellular structure 44 or a plurality of superposed cellular structures 44 separated by porous layers.

According to one configuration, the cellular structure 44 comprises at least one cellular reinforcement 44.1, which has a triangular or trapezoid section, positioned at a first edge from among the front and rear edges 40.1, 40.2. At this first edge, the reflective layer 46 is pressed against the acoustically resistive layer 42 and connected thereto.

The acoustic attenuation panel 40 comprises at least one C-shaped reinforcement 50, interposed between the acoustically resistive and reflective layers 42, 46, which has a web 50.1 and first and second wings 50.2, 50.3 situated at the ends of the web 50.1, the first wing 50.2 being pressed against the acoustically resistive layer 42 and connected thereto, the second wing 50.3 being pressed against the reflective layer 46 and connected thereto. According to one arrangement, the C-shaped reinforcement 50 is positioned at the rear edge 40.2. Of course, the invention is not limited to this arrangement.

The web 50.1, the first and second wings 50.2, 50.3 of the C-shaped reinforcement 50 form a one-piece component.

According to one embodiment, the C-shaped reinforcement 50 is a preform of fibers which are or are not pre-impregnated.

The acoustically resistive layer (or layers) 42, the cellular structure (or structures) 44, the reflective layer 46 and the C-shaped reinforcement (or reinforcements) are not described in more detail because they may be identical to those of the prior art. The methods for obtaining them are not described in more detail because they may be identical to those of the prior art.

According to one configuration, when the acoustic attenuation panel 40 is finished, the first and second wings 50.2, 50.3 of the C-shaped reinforcement 50 are substantially parallel and spaced apart by a given spacing. The first and second wings 50.2, 50.3 have (between their free ends and the web 50.1) substantially identical given widths.

According to the invention, the acoustic attenuation panel 40 comprises at least one expandable core 52 positioned between the first and second wings 50.2, 50.3 of a C-shaped reinforcement 50 and configured to occupy a non-expanded first state, at a first temperature, in which the expandable core 52 occupies a first volume, and an expanded second state, at a second temperature greater than the first temperature, in which the expandable core 52 occupies a second volume greater than the first volume. According to one configuration, the first temperature is equal to an ambient temperature, of the order of 20° C., and the second temperature is equal to a polymerization temperature greater than or equal to 100° C.

According to a first embodiment, at least one expandable core 52 is produced from a solid material such as an expandable foam.

According to a second embodiment, at least one expandable core 52 comprises at least one bladder containing an expandable fluid.

According to one arrangement, the expandable core 52 has, in the first state, shapes which conform to the shapes of the web 50.1 and those of the first and second wings 50.2, 50.3 of the C-shaped reinforcement 50.

According to one embodiment, the expandable core 52 has, in the first state, a substantially rectangular section which has a length substantially equal to the given spacing between the first and second wings 50.2, 50.3 and a width substantially equal to that of the first and second wings 50.2, 50.3.

The acoustic attenuation panel 40 may comprise a single expandable core 52 or a plurality of expandable cores placed end to end. Thus, in the case of an acoustic attenuation panel 40 of tubular shape, the latter may comprise a single expandable core which extends around the entire circumference of the tubular shape or a plurality of expandable cores 52, placed end to end, which extend around the entire circumference of the tubular shape.

According to cases, at least one expandable core 52 is removed from the acoustic attenuation panel 40 after a polymerization step. In a variant, at least one expandable core 52 is permanently positioned in the acoustic attenuation panel 40.

According to one operating mode, a method for manufacturing an acoustic attenuation panel comprises a first step of placing an acoustically resistive layer 42 on a first mold, a step of introducing at least one C-shaped reinforcement 50, a step of winding a wire 48 around the acoustically resistive layer 42, a step of introducing at least one expandable core 52 between the first and second wings 50.2, 50.3 of the C-shaped reinforcement 50, a step of introducing said cellular structure 44 onto the already positioned acoustically resistive layer 42, a step of introducing the reflective layer 46, a step of introducing at least one polymerization tool, a polymerization cycle, and then a demolding step.

Regardless of the operating mode, a method for manufacturing an acoustic attenuation panel 40 comprises a step of introducing at least one acoustically resistive layer 42, at least one C-shaped reinforcement 50 having a web 50.1 and first and second wings 50.2, 50.3, at least one expandable core 52 between the first and second wings 50.2, 50.3 of the C-shaped reinforcement, at least one cellular structure 44 and at least one reflective layer 46; the cellular structure 44 and the C-shaped reinforcement 50 being situated between the acoustically resistive layer 42 and the reflective layer 46. After these elements have been introduced, the method comprises a step of introducing at least one polymerization tool, a polymerization cycle and a demolding step. In all cases, each expandable core 52 is introduced prior to the polymerization cycle, notably prior to the step of introducing the cellular structure 44.

During the polymerization cycle, the expandable core 52 expands and increases in volume. The expansion of the expandable core 52 during the polymerization cycle allows it to compensate for expansion phenomena and to exert a compressive load on the web 50.1 and on the first and second wings 50.2, 50.3 against respectively the acoustically resistive layer 42 and the reflective layer 46. Furthermore, the expandable core 52 prevents the C-shaped reinforcement 50 from deforming and allows it to react the compressive loads which tend to move the reflective layer 46 and the acoustically resistive layer 42 toward one another during the polymerization cycle.

Contrary to the prior art, the manufacturing method comprises only a single polymerization cycle, enabling a reduction in the time and the manufacturing costs.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An acoustic attenuation panel comprising:
at least one acoustically resistive layer;
at least one reflective layer;
at least one cellular structure; and
at least one C-shaped reinforcement interposed between the at least one acoustically resistive layer and the at least one reflective layer,
said at least one C-shaped reinforcement comprising
a web and a first wing and a second wing in contact respectively with the at least one acoustically resistive layer and the at least one reflective layer,
wherein the acoustic attenuation panel further comprises at least one expandable core positioned between the first wing and the second wing of the at least one C-shaped reinforcement and configured to occupy a non-expanded first state, at a first temperature, in which the at least one expandable core occupies a first volume, and an expanded second state, at a second temperature greater than the first temperature, in which the at least one expandable core occupies a second volume greater than the first volume.

2. The acoustic attenuation panel as claimed in claim 1, wherein the at least one expandable core comprises, in the first state, shapes which conform to those of the web and that of the first wing and the second wing of the at least one C-shaped reinforcement.

3. The acoustic attenuation panel as claimed in claim 2, wherein the at least one expandable core comprises, in the first state, a substantially rectangular section which has a length substantially equal to a spacing between the first wing and the second wing and a width substantially equal to that of the first wing and the second wing.

4. The acoustic attenuation panel as claimed in claim 1, wherein the at least one acoustic attenuation panel comprises a plurality of expandable cores placed end to end.

5. The acoustic attenuation panel as claimed in claim 1, wherein the at least one expandable core is produced from a solid material.

6. The acoustic attenuation panel as claimed in claim 1, wherein the at least one expandable core comprises at least one bladder containing an expandable fluid.

7. The acoustic attenuation panel as claimed in claim 1, wherein at least one expandable core is permanently positioned in the acoustic attenuation panel.

8. The acoustic attenuation panel as claimed in claim 1, wherein the first temperature is equal to an ambient temperature and the second temperature is equal to a polymerization temperature greater than or equal to 100° C.

9. A method for manufacturing an acoustic attenuation panel, the manufacturing method comprising:
providing at least one acoustically resistive layer, at least one C-shaped reinforcement, at least one cellular structure, and at least one reflective layer, the at least one cellular structure and the at least one C-shaped reinforcement being interposed between the at least one acoustically resistive layer and the at least one reflective layer, said at least one C-shaped reinforcement comprising a web and a first wing and a second wing in contact respectively with the at least one acoustically resistive layer and the at least one reflective layer;
providing at least one polymerization tool;
performing a polymerization cycle; and demolding an acoustic attenuation panel from the at least one polymerization tool;
wherein the method further comprises introducing at least one expandable core between the first wing and the second wing of the C-shaped reinforcement prior to the polymerization cycle, said at least one expandable core being configured to occupy a non-expanded first state, at a first temperature, in which the at least one expandable core occupies a first volume, and an expanded second state, at a second temperature greater than the first temperature, in which the at least one expandable core occupies a second volume greater than the first volume.
